(19) United States
(12) Patent Application Publication
(10) Pub. No.: US 2024/0278575 A1
(43) Pub. Date: Aug. 22, 2024

(54) WATER REPELLENT MEMBER, INKJET HEAD, METHOD OF MANUFACTURING THE WATER REPELLENT MEMBER, AND METHOD OF MANUFACTURING THE INKJET HEAD

(71) Applicant: CANON KABUSHIKI KAISHA, Tokyo (JP)

(72) Inventors: JUNRI ISHIKURA, Tokyo (JP); YOHEI MIYAUCHI, Tokyo (JP); TADAHIRO MIMURA, Kanagawa (JP); KOJI SASAKI, Chiba (JP)

(21) Appl. No.: 18/419,716

(22) Filed: Jan. 23, 2024

(30) Foreign Application Priority Data
Feb. 14, 2023 (JP) 2023-020655

(51) Int. Cl. B41J 2/165; B41J 2/16

(52) U.S. Cl. CPC B41J 2/16538; B41J 2/1606; B41J 2/164; B41J 2/16502; B41J 2202/03

(57) ABSTRACT

A method of manufacturing a water repellent member includes forming a base layer on a foundation material, forming projections on the base layer such that the projections are dispersed, and forming a water repellent film that contains a perfluoropolyether compound, and that is in contact with the base layer and the projections. The projections contain a main component whose covalent binding index is larger than a covalent binding index of a main component of the base layer.

### BACKGROUND OF THE INVENTION

### Field of the Invention

The present invention relates to a water repellent member, and an inkjet head that includes the water repellent member.

### Description of the Related Art

The bubble jet (registered trademark), the piezo jet, and the like are known as devices (hereinafter referred to as inkjet heads) that eject ink. The bubble jet flies droplets by instantly vaporizing the ink by using a heater, and the piezo jet urges droplets by using a piezoelectric element. For recording a high-quality image by using the inkjet head, it is necessary to eject ink droplets from an ink ejection orifice along a predetermined direction, with sufficient straightness. However, if residual droplets stick to an orifice plate surface around the ejection orifice, ink droplets may be pulled by the residual droplets when the ink droplets are ejected. As a result, the ejection direction may be bent; and the ink droplets may fly, deviated from the predetermined direction. For this reason, a water repellent film is formed in the vicinity of the ink ejection orifice, for suppressing the residual droplets from sticking to the surface around the ink ejection orifice.

Japanese Patent Application Publication No. 2002-127429 proposes a method of manufacturing the inkjet head. For preventing the water repellent film from being damaged and the ejection orifice from being clogged when the inkjet head is manufactured, the method includes a process for forming a protection member and a process for removing the protection member.

In general, the surface of the inkjet head is cleaned by using a wiper for removing the paper powder and the dirt. However, if the cleaning operation is performed by using the wiper, the water repellent film may be peeled off. Since the method described in Japanese Patent Application Publication No. 2002-127429 is a technique for preventing the damage of the water repellent film when the inkjet head is manufactured, the method cannot prevent the peeling of the water repellent film in the cleaning operation performed by using the wiper.

Japanese Patent Application Publication No. 2000-229410 proposes a water repellent structure. In the water repellent structure, a projection-and-recess structure is formed on a foundation material, and a water repellent film is formed on the surface of the projection-and-recess structure. The projection-and-recess structure is formed regularly by using the photolithography, and the etching depth of the projection-and-recess structure is equal to or smaller than 10 μm.

### SUMMARY OF THE INVENTION

According to a first aspect of the present invention, a water repellent member includes a foundation material, a base layer formed on the foundation material, projections formed on the base layer and dispersed, a first water-repellent member formed on the base layer in contact with the base layer, and a second water-repellent member formed on the projections in contact with the projections. The first water-repellent member and the second water-repellent member are a perfluoropolyether compound. If an oxide that is a main component of the base layer is denoted by AO, an oxide that is a main component of the projections is denoted by BO, an electronegativity of an element A is denoted by XA, an electronegativity of an element B is denoted by XB, and an electronegativity of oxygen is denoted by XO, a covalent binding index exp(−0.25(XA−XO)²) of the AO is smaller than a covalent binding index exp(−0.25(XB−XO)²) of the BO.

According to a second aspect of the present invention, an inkjet head includes an orifice plate including an ejection orifice. The orifice plate includes a foundation material, a base layer formed on the foundation material, projections formed on the base layer and dispersed, a first water-repellent member formed on the base layer in contact with the base layer, and a second water-repellent member formed on the projections in contact with the projections. The first water-repellent member and the second water-repellent member are a perfluoropolyether compound. If an oxide that is a main component of the base layer is denoted by AO, an oxide that is a main component of the projections is denoted by BO, an electronegativity of an element A is denoted by XA, an electronegativity of an element B is denoted by XB, and an electronegativity of oxygen is denoted by XO, a covalent binding index exp(−0.25(XA−XO)²) of the AO is smaller than a covalent binding index exp(−0.25(XB−XO)²) of the BO.

According to a third aspect of the present invention, a method of manufacturing a water repellent member includes forming a base layer on a foundation material, forming projections on the base layer such that the projections are dispersed, the projections containing a main component whose covalent binding index is larger than a covalent binding index of a main component of the base layer, and forming a water repellent film that contains a perfluoropolyether compound, and that is in contact with the base layer and the projections.

Further features of the present invention will become apparent from the following description of exemplary embodiments with reference to the attached drawings.

### BRIEF DESCRIPTION OF THE DRAWINGS

FIG. 1 is a perspective view illustrating an external appearance of an inkjet head that is one example of an embodiment.

FIG. 2A is a schematic cross-sectional view in which one portion of a cross section of an orifice plate of an embodiment is enlarged and schematically illustrated.

FIG. 2B is a diagram illustrating a state in which a droplet is in contact with the orifice plate of the embodiment.

FIG. 3A is a diagram illustrating one example of a cleaning operation performed by using a wiper.

FIG. 3B is a diagram illustrating another example of the cleaning operation performed by using a wiper.

FIG. 4 is a schematic enlarged view for illustrating a slide of a wiping member.

FIG. 5A is a schematic cross-sectional view illustrating a cross section of the orifice plate of the embodiment, obtained after the cleaning operation performed by using a wiper.

FIG. 5B is a diagram illustrating a state in which a recess portion that serves as an air pocket is kept in the orifice plate of the embodiment even after the cleaning operation performed by using the wiper.

FIG. 6A is a schematic diagram illustrating a conventional water repellent structure in which a water repellent film having a uniform physical property is formed on a base having projections and recesses.

FIG. 6B is a schematic diagram illustrating the conventional water repellent structure in which the projection portions are consumed (worn) in the cleaning operation performed by using the wiper.

### DESCRIPTION OF THE EMBODIMENTS

As described in Japanese Patent Application Publication No. 2000-229410, in the structure in which the water repellent film is formed on the fine and regular projection-and-recess structure, the adhesiveness between the water repellent film and the base can be increased, and the peeling of the film (i.e., the falling off of the film from the base body) can be reduced in the wiping.

However, in the structure described in Japanese Patent Application Publication No. 2000-229410, even if the film is not peeled off (or the film does not fall off from the base body), there is a tendency that the projection portions are locally and mainly consumed (worn) by the slide. This is because the contact load is applied, in the wiping, mainly on a portion of the water repellent film formed on the projection portions. Thus, if the wiping is performed repeatedly, the water repellent film formed on the projection portions, which easily contacts droplets, is consumed early, so that a period of time in which the initial water-repellent performance is kept is shortened, and the practical service life of the inkjet head is shortened. Thus, if the inkjet ejection apparatus is a head-replaceable inkjet ejection apparatus, the replacement cycle of the head is shortened; if the inkjet ejection apparatus is a head-irreplaceable inkjet ejection apparatus, the service life of the apparatus itself is shortened.

For this reason, in the field of inkjet heads, it has been desired to achieve a water repellent member that can keep the water repellency for a longer time even though the wiping is performed.

Next, a water repellent member, an inkjet head, and the like of an embodiment of the present invention will be described with reference to the accompanying drawings.

Note that since the embodiments described below are examples, detailed configurations and the like may be modified as appropriate by a person skilled in the art, without departing the spirit of the present invention.

In addition, in the drawings referred to in the below-described embodiments and examples, a component given an identical reference numeral has an identical function, unless otherwise specified.

### Inkjet Head

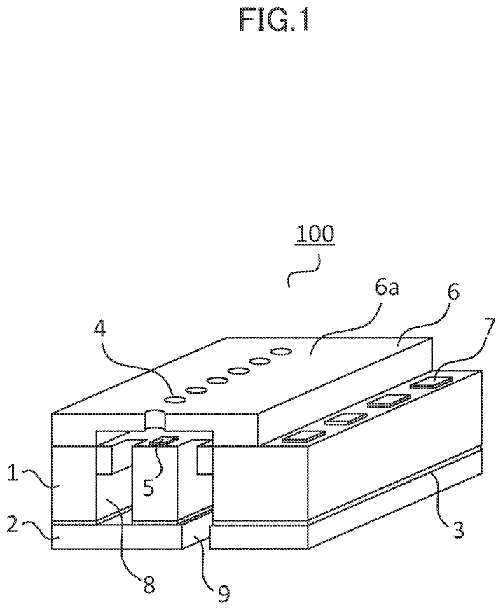

FIG. 1 is a perspective view illustrating an external appearance of an inkjet head that is one example of an embodiment of the present invention. An inkjet head 100 includes a first flow-channel substrate 1, a second flow-channel substrate 2, an adhesive 3, ejection orifices 4, ejection-energy generation elements 5, an orifice plate 6 that includes an orifice surface 6a, and electrodes 7. Note that other components (such as wirings) of the inkjet head that are not directly related to the description of the present invention are not illustrated in the figure.

The first flow-channel substrate 1 and the second flow-channel substrate 2 are bonded to each other via the adhesive 3, and the first flow-channel substrate 1 and the orifice plate 6 are bonded to each other via the adhesive 3. In this manner, the first flow-channel substrate 1, the second flow-channel substrate 2, and the orifice plate 6 are integrated with each other, and constitute a flow channel structure. In the flow channel structure, a penetrating first flow channel 8 and a penetrating second flow channel 9 are formed. The penetrating first flow channel 8 and the penetrating second flow channel 9 communicate with each other, and constitute an ink supply channel. Note that in FIG. 1, only one portion of the adhesive 3 is illustrated for convenience of description.

In the orifice plate 6, the plurality of ejection orifices 4 is formed in a line. However, the arrangement (number and positions) of the ejection orifices 4 is not limited to the example illustrated in FIG. 1. As described below, a water repellent structure of the present invention is formed on the outer surface, or the orifice surface 6a, of the orifice plate 6 formed around the ejection orifices 4. Thus, the orifice plate 6 can be called a water repellent member.

In the first flow-channel substrate 1, the ejection-energy generation elements 5 are disposed for ejecting liquid, at positions corresponding to the ejection orifices 4. The ejection-energy generation elements 5 are driven by electric signals transmitted from an external apparatus via the electrodes 7. Preferably, the ejection-energy generation elements 5 are electrothermal conversion elements or piezoelectric elements.

The liquid to be ejected is supplied from an ink tank (not illustrated) through the penetrating second flow channel 9 and the penetrating first flow channel 8. The liquid is supplied with the ejection energy by the ejection-energy generation elements 5, and is ejected from the ejection orifices 4.

### Water Repellent Member

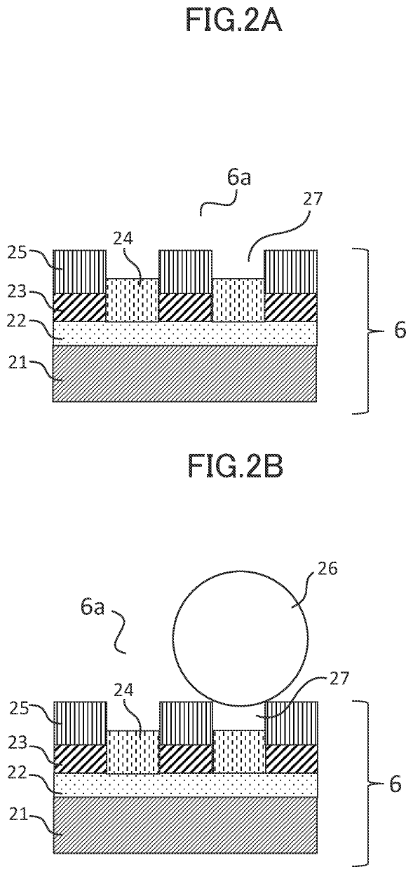

Next, a water repellent structure formed on the outer surface of the orifice plate 6, which is a water repellent member, will be described. FIG. 2A is a schematic cross-sectional view in which one portion of a cross section of the orifice plate 6 is enlarged and schematically illustrated. Note that since the figures are made schematically for convenience of description, the shape and size of each member are not necessarily the same as those of a real member. The orifice plate 6 includes a foundation material 21, a base layer 22, projections 23, a first water-repellent member 24, and a second water-repellent member 25.

The foundation material 21 is made of a material that has a necessary mechanical strength, and that is suitable for forming the ejection orifices 4 and the water repellent structure. For example, silicon, a metal material, a resin material, an inorganic material other than silicon, an inorganic oxide material, or a combination thereof is suitably used.

The base layer 22 formed on the foundation material 21 serves as a base of the first water-repellent member 24 and the projections 23. In the example illustrated in FIG. 2A, the base layer 22 is formed directly on the foundation material 21. However, a protective film for protecting the foundation material 21 from corrosion caused by the ink, or an adhesive layer for increasing the adhesiveness of the base layer 22 may be formed between the base layer 22 and the foundation material 21.

On the base layer 22, the plurality of fine projections 23 are formed and dispersed. The projections 23 are projection portions formed on the flat base layer 22. The projections 23 may be regularly formed as illustrated in FIG. 2A, or may be irregularly formed like naturally formed islands.

When the water repellent member is formed, the base layer 22 functions as a base for forming the first water-repellent member 24, and the projections 23 function as a base for forming the second water-repellent member 25. As described in detail below, the projections 23 are made of a material having a physical property (i.e., a covalent bond property) different from that of the base layer 22. The difference in the physical property causes water repellent members, which are the first water-repellent member 24 formed on the base layer 22 and the second water-repellent member 25 formed on the projections 23, to have different physical properties (i.e., densities). Thus, in the present embodiment, unlike Japanese Patent Application Publication No. 2000-229410, the projections and recesses of the substrate are not coated with a uniform water repellent film. Specifically, the water repellent structure is formed such that the first water-repellent member that forms the bottom surface of each recess portion and the second water-repellent member that forms each projection portion have different physical properties (i.e., densities).

The base layer 22 is made of a material whose covalent bond force is weaker than that of the material of the projections 23. The covalent bond force is expressed by using the covalent binding index, and increases as the covalent binding index increases. If the electronegativity of an element A is denoted by XA, and the electronegativity of oxygen is denoted by XO, the covalent binding index is expressed as exp(−0.25(XA−XO)²). The electronegativity of each element is described in “Handbook of Chemistry: Pure Chemistry II, 4th ed.” edited by The Chemical Society of Japan.

The oxide that is a main component of the base layer 22 is selected from the group consisting of an oxide, such as Ta₂O₅, Nb₂O₅, HfO₂, ZrO₂, or TiO₂, that includes a Group 4 or 5 element; an oxide, such as Y₂O₃ or CeO₂, that includes a Group 3 element; and a metal oxide, such as Al₂O₃ or Cr₂O₃. The base layer 22 may contain a mixture of the above-described oxides. The main component of the base layer 22 is a component that has the maximum weight percentage if the base layer 22 contains a plurality of components (materials). In this specification, the main component is a component that has a 50 or more weight percent.

The base layer 22 is formed by using an appropriate film forming method selected from a dry film-forming method, such as spattering, vacuum deposition, ALD, gas deposition, CVD, or thermal spraying, and a wet film-forming method such as slit coating, a transfer method, spin coating, or dip coating.

The projections 23 are made of a material whose covalent bond force is stronger than that of the material of the base layer 22. The oxide that is a main component of the projections 23 is selected from the group consisting of an oxide, such as SiO₂, Ta₂O₅, Nb₂O₅, HfO₂, ZrO₂, or TiO₂, that includes a Group 4 or 5 element; an oxide, such as Y₂O₃ or CeO₂, that includes a Group 3 element; or a metal oxide, such as Al₂O₃ or Cr₂O₃. The projections 23 may contain a mixture of the above-described oxides.

The projections 23 are formed by using an appropriate film forming method selected from a dry film-forming method, such as spattering, vacuum deposition, ALD, gas deposition, CVD, or thermal spraying, and a wet film-forming method such as slit coating, transfer method, spin coating, or dip coating. The projections 23 may be an islands-shaped structure (i.e., an irregular arrangement) formed in an early stage after the film formation is started in the vacuum film forming, or may be a predetermined pattern (i.e., a regular arrangement) formed through mask deposition or photolithography etching.

Table 1 shows an example of covalent binding indexes of the above-described oxides, calculated by using the following expression (1) and the electronegativity described in “Handbook of Chemistry: Pure Chemistry II, 4th ed.” edited by The Chemical Society of Japan.

exp(−0.25(XA−XO)²) (expression 1)

TABLE 1

| MATERIAL | SiO₂ | Cr₂O₃ | Al₂O₃ | Nb₂O5 | TiO₂ | Ta₂O5 | ZrO₂ | HfO₂ | Y₂O₃ | CeO₂ |
|---|---|---|---|---|---|---|---|---|---|---|
| COVALENT | 0.55 | 0.45 | 0.44 | 0.43 | 0.41 | 0.39 | 0.33 | 0.32 | 0.29 | 0.26 |
| BINDING | | | | | | | | | | |
| INDEX | | | | | | | | | | |

In the present embodiment, if the oxide that is a main component of the base layer is denoted by AO, the oxide that is a main component of the projections is denoted by BO, the electronegativity of an element A is denoted by XA, the electronegativity of an element B is denoted by XB, and the electronegativity of oxygen is denoted by XO, the covalent binding index exp(−0.25(XA−XO)²) of the oxide AO is smaller than the covalent binding index exp(−0.25(XB−XO)²) of the oxide BO.

The base layer 22 and the projections 23 constitute a base projection-and-recess structure that functions as a base for forming the water repellent film. The water repellent film is constituted by the first water-repellent member 24 and the second water-repellent member 25, which are formed on the base projection-and-recess structure and adjacent to each other. The surface of the water repellent film, constituted by the first water-repellent member 24 and the second water-repellent member 25, is a projection-and-recess surface formed in accordance with the shape of the base projection-and-recess structure. The projection-and-recess surface of the water repellent film includes a plurality of recess portions 27. The bottom surface of each of the recess portions 27 is defined by the first water-repellent member 24, and a side surface of each of the recess portions 27 is defined by the second water-repellent member 25. In addition, the surfaces (i.e., top portions of the projection-and-recess surface) that surround a recess portion 27 are defined by the second water-repellent member 25.

As schematically illustrated in FIG. 2B, in a state where a liquid (ink) 26 is in contact with the orifice surface 6a, the recess portion 27 functions as an air pocket. Since the recess portion 27 is formed in this manner, the area in which the liquid (ink) 26 is in contact with the orifice surface 6a is made smaller, so that the water repellency becomes easy and it becomes difficult for the liquid (ink) 26 to stick to the orifice surface 6a. That is, the water repellent performance of the orifice surface 6a can be increased by forming the orifice surface 6a by using a material with a large contact angle, and by forming the fine recess portions 27. Note that since FIG. 2B is a schematic diagram, FIG. 2B illustrates a state where the liquid (ink) 26 is supported by both projection portions (i.e., the second water-repellent member 25) that surround a single recess portion. However, if the liquid (ink) 26 has a larger size, a plurality of recess portions 27 will be interposed between the liquid (ink) 26 and the orifice surface 6a, as air pockets that separate the surface of the liquid and the orifice surface 6a from each other.

In the present embodiment, the first water-repellent member 24 and the second water-repellent member 25, which constitute the water repellent film, are made of a material with high water repellency. In addition to this, the water repellent material forms a film having a physical property (i.e., a density) that varies in accordance with a physical property (i.e., a covalent bond property) of the base material.

That is, the water repellent material forms a (less dense) film with a lower density if the base material has a lower covalent bond property, and forms a (dense) film with a higher density if the base material has a higher concentration of oxygen contained in the base material.

Specifically, a fluorine-based water-repellent material is used as the material of the first water-repellent member 24 and the second water-repellent member 25. In particular, a perfluoropolyether compound is preferably used as the material. The perfluoropolyether compound bonds to a base via oxygen. In addition, the perfluoropolyether compound more easily bonds to the base as the covalent bond force of metal atoms and oxygen atoms, which form the base oxide, increases. This is because in this case, the polarization decreases and the perfluoropolyether compound receives less attack from its surroundings (e.g., water). As a result, as the covalent bond force of the base oxide increases, the bonding amount increases and the dense film can be formed. For varying the density of the perfluoropolyether compound with location, the covalent binding index of the material of the projections 23 is preferably larger than that of the material of the base layer 22, by 0.1 or more.

The fluorine-based water-repellent material suitably used in the present embodiment is a perfluoropolyether compound that includes at least one of repeated structures expressed by the following structural formulas (1) to (4).

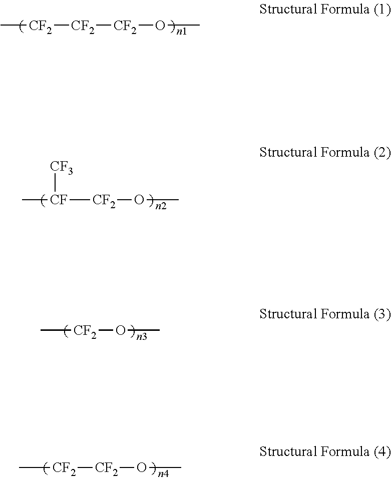

One example of the perfluoropolyether compound that can be used in the present embodiment is expressed by the following structural formula (5).

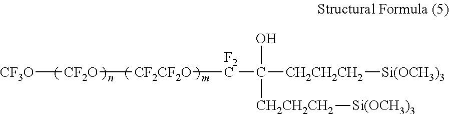

Note that the ratio of the CF₂O unit to the CF₂CF₂O unit, determined from integrated values of ¹⁹NMR spectra, is n:m=27:26. In addition, the molecular weight of a perfluoropolyether portion calculated from the number of units is about 5000.

In addition, the perfluoropolyether compound that can be used in the present embodiment is expressed, as a general formula, by the following structural formula (6).

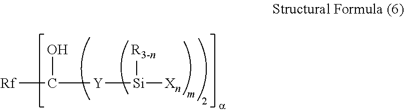

In this structural formula, a parameter Y is a hydrocarbon group with a valence of 2 to 6 that may have a siloxane bond or a silylene group, a parameter R is an alkyl group or a phenyl group that individually has a carbon number of 1 to 4, a parameter X individually represents a hydrolyzable group, a parameter n is an integer of 1 to 3, a parameter m is an integer of 1 to 5, and a parameter a is 1 or 2.

Note that a parameter Rf is expressed by the following structural formula (7).

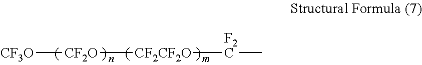

In the present embodiment, the covalent binding index of the material of the base layer 22 is lower than that of the projections 23, as described above. For this reason, the amount of the first water-repellent member 24 bonded to the base layer 22 is smaller than the amount of the second water-repellent member 25 bonded to the projections 23 (the first water-repellent member 24 is formed on the base layer 22, and the second water-repellent member 25 is formed on the projections 23). Thus, the density of the first water-repellent member 24 is lower than the density of the second water-repellent member 25. In other words, the second water-repellent member 25 is formed more densely than the first water-repellent member 24.

In the present embodiment, the second water-repellent member 25 is formed more densely than the first water-repellent member 24. Thus, even if the cleaning operation is performed on the orifice surface 6a by using a wiper, the recess portion 27 that functions as an air pocket is allowed to remain for a longer time.

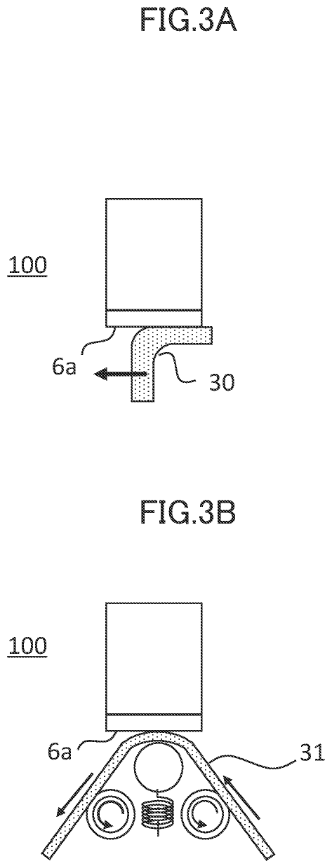

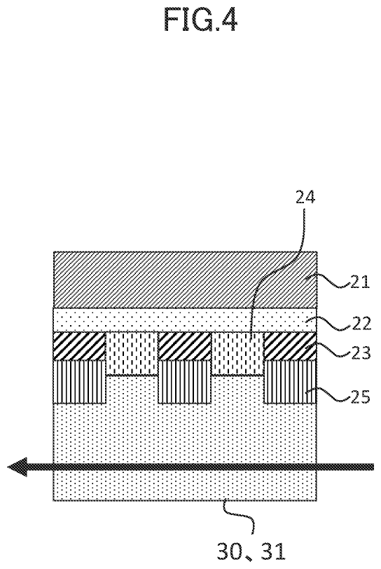

Next, typical cleaning operations performed by using a wiper will be described with reference to FIGS. 3A, 3B, and 4. FIG. 3A schematically illustrates a cleaning operation in which the orifice surface 6a of the inkjet head 100 is cleaned by moving a wiping member 30 in a direction indicated by an arrow in FIG. 3A, in a state where the wiping member 30 is in contact with the orifice surface 6a. The wiping member 30 is made of an elastic material, such as rubber or sponge, and is slid on the orifice surface 6a by a driving mechanism (not illustrated) while pressing the orifice surface 6a at an appropriate pressure. As another example, FIG. 3B schematically illustrates a cleaning operation in which the orifice surface 6a of the inkjet head 100 is cleaned by moving a belt-like wiping member 31 in a direction indicated by an arrow in FIG. 3B, in a state where the wiping member 31 is in contact with the orifice surface 6a. The wiping member 31 is made of an elastic material, such as nonwoven fabric or felt, and is slid on the orifice surface 6a while pressing the orifice surface 6a at an appropriate pressure.

As schematically illustrated in FIG. 4, if the wiping is performed by using such a wiping member, which is an elastic body, while the orifice surface 6a is pressed by the wiping member, the wiping member elastically deforms, and slides in contact with both of the first water-repellent member 24 and the second water-repellent member 25. When the wiping member slides, stronger resistance force is applied more to the projecting second water-repellent member 25 than to the first water-repellent member 24, which forms the bottom surface of a recess portion. If the cleaning operation is performed repeatedly in the use of the inkjet head 100, the water repellent film is gradually consumed (worn) by the slide of the wiping member on the water repellent film.

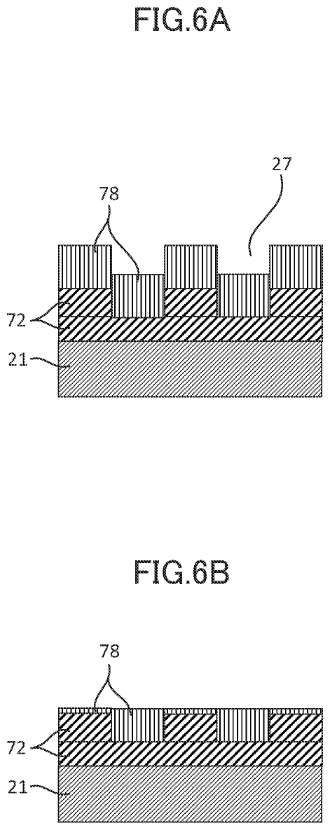

If the inkjet head is formed, as illustrated in FIG. 6A, such that a base 72 having projections and recesses is coated with a water repellent film 78 that has a uniform physical property, the projection portions of the water repellent film 78 are locally and mainly consumed (worn) by the slide of the wiping member on the water repellent film. This is because larger friction caused by the slide of the wiping member is applied to the projection portions of the water repellent film. Thus, if the wiping is performed repeatedly, the projection portions of the water repellent film wear early than the bottom surface of each of the recess portions does. As a result, as illustrated in FIG. 6B, the recess portion 27 that serves as an air pocket disappears early, so that a period of time in which the initial water-repellent performance is kept is shortened, and the practical service life of the inkjet head is shortened.

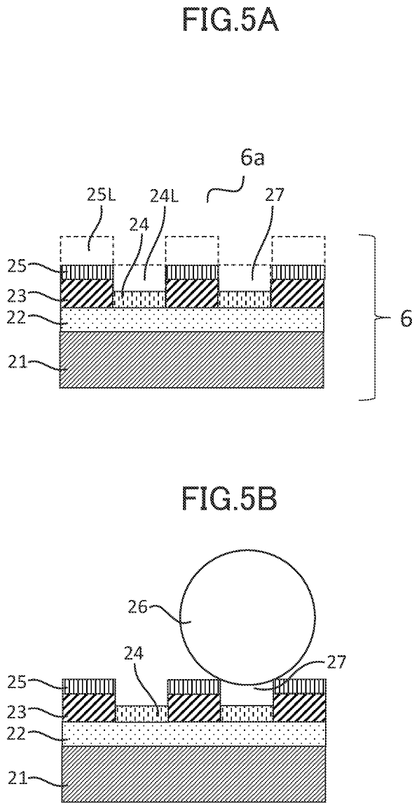

In contrast, in the present embodiment, the second water-repellent member 25 to which the stronger resistance force is applied is made more densely than the first water-repellent member 24, as described above. As a result, the speed at which the second water-repellent member 25 wears is not significantly different from the speed at which the first water-repellent member 24 wears. FIG. 5A schematically illustrates a cross section of the orifice surface 6a of the present embodiment, obtained after the cleaning operation is performed repeatedly. A portion that has disappeared due to the wear caused by the slide is indicated by a dotted line. Specifically, a portion of the first water-repellent member 24 that has disappeared due to the wear is denoted by 24L, and a portion of the second water-repellent member 25 that has disappeared due to the wear is denoted by 25L. The height of the portion 24L is substantially equal to the height of the portion 25L. Thus, as illustrated in FIG. 5B, even if the water repellent film is worn by the wiping, the recess portion 27 that functions as an air pocket is allowed to remain for a longer time. In other words, the difference in height between the first water-repellent member 24 and the second water-repellent member 25, obtained after the elastic member slides on the water repellent surface of the orifice plate (i.e., a water repellent member), is kept at a value that is substantially equal to the height of the projections 23. In other words, the speed at which the first water-repellent member 24 wears and the speed at which the second water-repellent member 25 wears, obtained when the elastic member slides on the orifice plate (i.e., a water repellent member), are substantially equal to each other.

Thus, in the orifice plate (i.e., a water repellent member) of the present embodiment, the imbalance in consumption of the water repellent member, produced when the orifice plate is cleaned by using a wiper, that is, the difference in consumption rate between the projection portions and the recess portions, is improved, so that the high water-repellent performance can be kept for a longer time.

### EXAMPLES

Hereinafter, specific examples and comparative examples will be described.

### Example 1

A film that serves as a base of a water repellent film, and the water repellent film that is made of perfluoropolyether were formed on a silicon substrate by using the following procedure. First, a Ta₂O₅ film was formed on the silicon substrate by using a vacuum deposition method that uses the electron beam heating. The back pressure of the chamber was set at a value equal to or smaller than 3×10⁻³ Pa, and the substrate was not heated when the film was formed. The power of the electron beam was controlled so that the film forming rate was kept at a constant value of 3 Å/s, by using a crystal oscillator monitor. The thickness of the film to be formed was set at 80 nm. For forming the film, the assisted deposition that uses oxygen was performed by using an ion gun. The covalent binding index of the Ta₂O₅ film formed in this manner is 0.39 according to the expression (1).

Then, an SiO₂ film was formed on the film by using a vacuum deposition method that uses the electron beam heating. The substrate was not heated when the film was formed, and the amount of introduction of oxygen was automatically adjusted so that the pressure was kept at 3×10⁻² Pa. The power of the electron beam was controlled so that the film forming rate was kept at a constant value of 3 Å/s, by using a crystal oscillator monitor. The formation of the film was stopped when the accumulated film thickness obtained by using the crystal oscillator monitor became 7 nm, so that islands-shaped fine SiO₂ projections were formed. The covalent binding index of the SiO₂ film formed in this manner is 0.55 according to the expression (1). In this manner, the projections and recesses that serve as the base of the water repellent film were formed (the base film includes the fine projections and the flat portions, and the covalent binding index of the fine projections is larger than that of the flat portions).

Then, the water repellent film made of perfluoropolyether was formed on the base film formed on the silicon substrate, by using a vacuum deposition method that uses the resistance heating. The water-repellent film material was SURFCLEAR100 made by Canon Optron, Inc. and having a skeleton expressed by the structural formula (2). For forming the film, the resistance heating was performed for one minute, by flowing a current of 200 A. The substrate was not heated, no gas was introduced into the chamber, and the formation of the film was started when the back pressure of the chamber became 3×10⁻³ Pa. In this manner, the water repellent film made of perfluoropolyether was formed on the base having projections and recesses, so that the water repellent film of Example 1 was made (the base includes the fine projections and the flat portions, and the covalent binding index of the fine projections is larger than that of the flat portions).

Then, a wipe-and-slide test was performed on the film formed in this manner, and the static contact angle of the film was measured before and after the wipe-and-slide test, by using pure water. In the slide test, a piece of sandpaper having a roughness of #3000 was used as a wiper, the load was set at 400 grams, and the number of times of sliding was set at 6000. As a result, the contact angle was 108 in both measurements performed before and after the sliding. Thus, it was confirmed that the deterioration caused by the sliding can be suppressed and the initial water-repellent performance can be kept.

### Comparative Example 1

For a comparison, another base film was formed and a water repellent film was formed on the base film, by using the following method. The base film has a uniform composition, and thus the covalent binding index is not distributed in the projection portions and the flat portions of the base film. First, a Ta₂O₅ film was formed on a silicon substrate by using a vacuum deposition method that uses the electron beam heating. The back pressure of the chamber was set at a value equal to or smaller than 3×10⁻³ Pa, and the substrate was not heated when the film was formed. The power of the electron beam was controlled so that the film forming rate was kept at a constant value of 3 Å/s, by using a crystal oscillator monitor. The thickness of the film to be formed was set at 80 nm. For forming the film, the assisted deposition that uses oxygen was performed by using an ion gun. The covalent binding index of the Ta₂O₅ film formed in this manner is 0.39 according to the expression (1).

Then, fine Ta₂O₅ projections having an islands-shaped structure were formed by using a vacuum deposition method that uses the electron beam heating. When the fine Ta₂O₅ projections were formed, oxygen was introduced into the chamber, and the degree of vacuum was kept at 3×10⁻² Pa. In addition, the film forming rate was controlled so as to be kept at 1 Å/s, by using a crystal oscillator monitor; and the formation of the film was stopped when the accumulated film thickness became 7 nm. The substrate was not heated, and the assisted deposition that uses an ion gun was not performed when the film was formed. In this manner, the islands-shaped fine Ta₂O₅ projections were formed on the Ta₂O₅ film. The covalent binding index of the Ta₂O₅ projections formed in this manner is 0.39 according to the expression (1).

Then, as in Example 1, a water repellent film made of perfluoropolyether as a water repellent material was formed. The water-repellent material was SURFCLEAR100 made by Canon Optron, Inc. For forming the film, the resistance heating was performed for one minute, for heating the water repellent material by flowing a current of 200 A. The substrate was not heated, no gas was introduced into the chamber, and the film was formed at a degree of vacuum of 3×10⁻³ Pa. In this manner, the water repellent film made of perfluoropolyether was formed on the Ta₂O₅ base having projections and recesses, so that the water repellent member of Comparative Example 1 was made (the Ta₂O₅ base includes the fine projections and the flat portions, and the covalent binding index of the fine projections is equal to that of the flat portions).

Then, the wipe-and-slide test and evaluation were performed on the film formed in this manner, under the same conditions as those of Example 1. As a result, the contact angle obtained before the sliding was 110, whereas the contact angle obtained after the 6000 times of sliding decreased to 80°. Thus, it was confirmed that the initial high water-repellent performance was deteriorated by the sliding.

### Comparative Example 2

For another comparison, another base film was formed and a water repellent film was formed on the base film, by using the following method. The base film has a uniform composition, and thus the covalent binding index is not distributed in the projection portions and the flat portions of the base film. First, an SiO₂ film was formed on a silicon substrate by using a vacuum deposition method that uses the electron beam heating. The back pressure of the chamber was set at a value equal to or smaller than 3×10⁻³ Pa. When the film was formed, oxygen was introduced into the chamber, the degree of vacuum was kept at 3×10⁻² Pa, and the substrate was heated at 200° C. In addition, the power of the electron beam was controlled so that the film forming rate was kept at a constant value of 3 Å/s, by using a crystal oscillator monitor. The thickness of the film to be formed was set at 80 nm. The covalent binding index of the SiO₂ film formed in this manner is 0.55 according to the expression (1).

Then, fine SiO₂ projections having an islands-shaped structure were formed by using a vacuum deposition method that uses the electron beam heating. When the fine SiO₂ projections were formed, oxygen was introduced into the chamber, and the degree of vacuum was kept at 3×10⁻² Pa. In addition, the film forming rate was controlled so as to be kept at 1 Å/s, by using a crystal oscillator monitor; and the formation of the film was stopped when the accumulated film thickness obtained by using the crystal oscillator monitor became 7 nm. In addition, the temperature of the substrate was kept at 200° C. In this manner, the islands-shaped fine SiO₂ projections were formed on the SiO₂ film. The covalent binding index of the SiO₂ projections formed in this manner is 0.55 according to the expression (1).

Then, in a state where the vacuum deposition apparatus was cooled fully, a water repellent film made of perfluoropolyether as a water repellent material was formed. The water-repellent material was SURFCLEAR100 made by Canon Optron, Inc. For forming the film, the resistance heating was performed for one minute, for heating the water repellent material by flowing a current of 200 A. The substrate was not heated, no gas was introduced into the chamber, and the film was formed at a degree of vacuum of 3×10⁻³ Pa. In this manner, the water repellent film made of perfluoropolyether was formed on the SiO₂ base having projections and recesses, so that the water repellent member of Comparative Example 2 was made (the SiO₂ base includes the fine projections and the flat portions, and the covalent binding index of the fine projections is equal to that of the flat portions).

Then, the wipe-and-slide test and evaluation were performed on the film formed in this manner, under the same conditions as those of Example 1. As a result, the contact angle obtained before the sliding was 110, whereas the contact angle obtained after the 6000 times of sliding decreased to 82°. Thus, it was confirmed that the initial high water-repellent performance was deteriorated by the sliding.

### Example 2

A base film and a water repellent film made of perfluoropolyether were formed on a silicon substrate by using the following procedure. First, an HfO₂ film was formed by using a vacuum deposition method that uses the electron beam heating. When the film was formed, oxygen was introduced into the chamber, and the degree of vacuum was kept at 3×10⁻² Pa. In addition, the substrate was heated at 150° C., and the film forming rate was controlled so as to be kept at 3 Å/s, by using a crystal oscillator monitor. The thickness of the film to be formed was set at 50 nm. The covalent binding index of the HfO₂ film formed in this manner is 0.32 according to the expression (1).

Then, islands-shaped SiO₂ film was formed on the film by using a vacuum deposition method that uses the electron beam heating. The substrate was not heated when the SiO₂ film was formed, and the amount of introduction of oxygen was automatically adjusted so that the pressure was kept at 3×10⁻² Pa. The power of the electron beam was controlled so that the film forming rate was kept at a constant value of 3 Å/s, by using a crystal oscillator monitor. The formation of the film was stopped when the accumulated film thickness obtained by using the crystal oscillator monitor became 7 nm, so that islands-shaped fine SiO₂ projections were formed. The covalent binding index of the SiO₂ projections formed in this manner is 0.55 according to the expression (1). In this manner, the projections and recesses that serve as the base of the water repellent film were formed (the base film includes the fine projections and the flat portions, and the covalent binding index of the fine projections is larger than that of the flat portions).

Then, the water repellent film made of perfluoropolyether was formed on the base film formed on the silicon wafer, by using a vacuum deposition method that uses the resistance heating. The water-repellent film material was SURFCLEAR100 made by Canon Optron, Inc. and having a skeleton expressed by the structural formula (2). For forming the film, the resistance heating was performed for one minute, by flowing a current of 200 A. The substrate was not heated, no gas was introduced into the chamber, and the formation of the film was started when the back pressure of the chamber became 3×10⁻³ Pa. In this manner, the water repellent film made of perfluoropolyether was formed on the base having projections and recesses, so that the water repellent film of Example 2 was made (the base includes the fine projections and the flat portions, and the covalent binding index of the fine projections is larger than that of the flat portions).

Then, a wipe-and-slide test was performed on the film formed in this manner, and the static contact angle of the film was measured before and after the wipe-and-slide test, by using pure water. In the slide test, a piece of sandpaper having a roughness of #3000 was used as a wiper, the load was set at 400 grams, and the number of times of sliding was set at 6000. As a result, the contact angle was 110 in both measurements performed before and after the sliding. Thus, it was confirmed that the deterioration caused by the sliding can be suppressed and the initial water-repellent performance can be kept.

### Example 3

A base film and a water repellent film made of perfluoropolyether were formed on a silicon substrate by using the following procedure. First, an Nb₂O₅ film was formed on the silicon substrate by using a vacuum deposition method that uses the electron beam heating. The back pressure of the chamber was set at a value equal to or smaller than 3×10⁻³ Pa, and the substrate was not heated when the film was formed. The power of the electron beam was controlled so that the film forming rate was kept at a constant value of 3 Å/s, by using a crystal oscillator monitor. The thickness of the film to be formed was set at 80 nm. For forming the film, the assisted deposition that uses oxygen was performed by using an ion gun. The covalent binding index of the Nb₂O₅ film formed in this manner is 0.43 according to the expression (1).

Then, an SiO₂ film was formed on the film by using a vacuum deposition method that uses the electron beam heating. The substrate was not heated when the SiO₂ film was formed, and the amount of introduction of oxygen was automatically adjusted so that the pressure was kept at 3×10⁻² Pa. The power of the electron beam was controlled so that the film forming rate was kept at a constant value of 3 Å/s, by using a crystal oscillator monitor. The formation of the film was stopped when the accumulated film thickness obtained by using the crystal oscillator monitor became 7 nm, so that islands-shaped fine SiO₂ projections were formed. The covalent binding index of the SiO₂ projections formed in this manner is 0.55 according to the expression (1). In this manner, the projections and recesses that serve as the base of the water repellent film were formed (the base film includes the fine projections and the flat portions, and the covalent binding index of the fine projections is larger than that of the flat portions).

Then, the water repellent film made of perfluoropolyether was formed on the base film formed on the silicon substrate, by using a vacuum deposition method that uses the resistance heating. The water-repellent film material was OPTOOL DSX-E made by DAIKIN INDUSTRIES, LTD. and having a skeleton expressed by the structural formula (1). For forming the film, the resistance heating that uses a cup-shaped molybdenum boat was performed for one minute, by flowing a current of 160 A. The substrate was not heated, no gas was introduced into the chamber, and the film was formed at 3×10⁻³ Pa.

In this manner, the water repellent film made of perfluoropolyether was formed on the base having projections and recesses, so that the water repellent film of Example 3 was made (the base includes the fine projections and the flat portions, and the covalent binding index of the fine projections is larger than that of the flat portions). Then, a wipe-and-slide test was performed on the film formed in this manner, and the static contact angle of the film was measured before and after the wipe-and-slide test, by using pure water. In the slide test, a piece of sandpaper having a roughness of #3000 was used as a wiper, the load was set at 400 grams, and the number of times of sliding was set at 6000. As a result, the contact angle was 105 in both measurements performed before and after the slide test. Thus, it was confirmed that the deterioration caused by the sliding can be suppressed and the initial water-repellent performance can be kept.

### Example 4

A base film and a water repellent film made of perfluoropolyether were formed on a silicon substrate by using the following procedure. First, a ZrO₂ film was formed on the silicon substrate by using a vacuum deposition method that uses the electron beam heating. The back pressure of the chamber was set at a value equal to or smaller than 3×10⁻³ Pa, and the substrate was not heated when the film was formed. The power of the electron beam was controlled so that the film forming rate was kept at a constant value of 3 Å/s, by using a crystal oscillator monitor. The thickness of the film to be formed was set at 80 nm. For forming the film, the assisted deposition that uses oxygen was performed by using an ion gun. The covalent binding index of the ZrO₂ film formed in this manner is 0.33 according to the expression (1).

Then, an SiO₂ film was formed on the film by using a vacuum deposition method that uses the electron beam heating. The substrate was not heated when the SiO₂ film was formed, and the amount of introduction of oxygen was automatically adjusted so that the pressure was kept at 3×10⁻² Pa. The power of the electron beam was controlled so that the film forming rate was kept at a constant value of 3 Å/s, by using a crystal oscillator monitor. The formation of the film was stopped when the accumulated film thickness obtained by using the crystal oscillator monitor became 7 nm, so that islands-shaped fine SiO₂ projections were formed. The covalent binding index of the SiO₂ projections formed in this manner is 0.55 according to the expression (1). In this manner, the projections and recesses that serve as the base of the water repellent film were formed (the base film includes the fine projections and the flat portions, and the covalent binding index of the fine projections is larger than that of the flat portions).

Then, the water repellent film made of perfluoropolyether was formed on the base film formed on the silicon substrate, by using a vacuum deposition method that uses the resistance heating. The water-repellent film material was SURFCLEAR300 made by Canon Optron, Inc. and having a skeleton expressed by the structural formula (2).

For forming the film, the resistance heating was performed for one minute, by flowing a current of 200 A. The substrate was not heated, no gas was introduced into the chamber, and the film was formed at 3×10⁻³ Pa. In this manner, the water repellent film made of perfluoropolyether was formed on the base having projections and recesses, so that the water repellent film of Example 4 was made (the base includes the fine projections and the flat portions, and the covalent binding index of the fine projections is larger than that of the flat portions).

Then, a wipe-and-slide test was performed on the film formed in this manner, and the static contact angle of the film was measured before and after the wipe-and-slide test, by using pure water. In the slide test, a piece of sandpaper having a roughness of #3000 was used as a wiper, the load was set at 400 grams, and the number of times of sliding was set at 6000. As a result, the contact angle was 105 in both measurements performed before and after the sliding. Thus, it was confirmed that the deterioration caused by the sliding can be suppressed and the initial water-repellent performance can be kept.

### Example 5

By using an orifice plate on which the water repellent process as described in Example 1 has been performed, an inkjet head illustrated in FIG. 1 was made. Note that the inkjet head illustrated in FIG. 1 was made as follows, in consideration of mass productivity. That is, each process described below was performed on a wafer, and a plurality of inkjet heads was formed collectively. Then, the water repellent film was formed on the wafer, and the dicing was performed on the wafer for dividing the wafer into the plurality of inkjet heads.

First, by performing the RIE process that uses the photolithography, the first flow-channel substrate 1 and the second flow-channel substrate 2 were made. The first flow-channel substrate 1 is a silicon substrate in which a groove that serves as an ink flow channel is formed, and the second flow-channel substrate 2 is a silicon substrate in which a groove that serves as an ink flow channel is formed. Note that the ejection-energy generation elements 5 made of TaSiN, the electrodes 7 made of Au, the silicon protection film (not illustrated) made of TiO, and the like are formed in the silicon substrate before or after the formation of the groove. In addition, by performing the RIE process that uses the photolithography, the orifice plate 6 was made. The orifice plate 6 is another silicon substrate in which a groove that serves as an ink flow channel is formed, and in which the ejection orifices 4 are formed by performing the Bosch process.

The first flow-channel substrate 1, the second flow-channel substrate 2, and the orifice plate 6 made in this manner were stuck to each other via adhesive, so that a plurality of inkjet heads was formed collectively. The adhesive used was a benzocyclobutene solution, and the first flow-channel substrate 1, the second flow-channel substrate 2, and the orifice plate 6 were stuck to each other by using a transfer method. These members to which the adhesive had been transferred were heated and bonded to each other in a vacuum while the members were aligned with each other by an aligning-and-joining apparatus. After the bonding was completed, the members were cooled, and then taken out of the apparatus. After that, the heat treatment was performed on the members in an oven in an atmosphere of nitrogen, for curing the adhesive.

Finally, the base and the water repellent film were formed on the orifice surface 6a by using the same method as that of Example 1. First, a Ta₂O₅ film was formed on a silicon substrate that serves as the orifice surface 6a, by using a vacuum deposition apparatus. The back pressure of the chamber was set at a value equal to or smaller than 3×10⁻³ Pa, and the substrate was not heated when the film was formed. The power of the electron beam was controlled so that the film forming rate was kept at a constant value of 3 Å/s, by using a crystal oscillator monitor. The thickness of the film to be formed was set at 80 nm. For forming the film, the assisted deposition that uses oxygen was performed by using an ion gun. The covalent binding index of the Ta₂O₅ film formed in this manner is 0.39 according to the expression (1).

Then, an SiO₂ film was formed on the film by using a vacuum deposition method that uses the electron beam heating. The substrate was not heated when the SiO₂ film was formed, and the amount of introduction of oxygen was automatically adjusted so that the pressure was kept at 3×10⁻² Pa. The power of the electron beam was controlled so that the film forming rate was kept at a constant value of 3 Å/s, by using the crystal oscillator monitor. The formation of the film was stopped when the accumulated film thickness obtained by using the crystal oscillator monitor became 7 nm, so that islands-shaped fine SiO₂ projections were formed. The covalent binding index of the SiO₂ projections formed in this manner is 0.55 according to the expression (1). In this manner, the projections and recesses that serve as the base of the water repellent film were formed (the base film includes the fine projections and the flat portions, and the covalent binding index of the fine projections is larger than that of the flat portions).

Then, the water repellent film made of perfluoropolyether was formed by using a vacuum deposition method. The water-repellent film material was SURFCLEAR100 made by Canon Optron, Inc. and having a skeleton expressed by the structural formula (2). For forming the film, the resistance heating was performed for one minute, by flowing a current of 200 A. The substrate was not heated, no gas was introduced into the chamber, and the formation of the film was started when the degree of vacuum of the chamber became 3×10⁻³ Pa. In this manner, the water repellent film made of perfluoropolyether was formed on the base having projections and recesses (the base includes the fine projections and the flat portions, and the concentration of oxygen of the fine projections is larger than that of the flat portions).

After that, the dicing was performed on the wafer, and the wafer was divided into individual inkjet heads. In this manner, the inkjet head illustrated in FIG. 1 was completed. The inkjet head of Example 5 was then mounted in an inkjet recording apparatus that includes a wiping mechanism, and a practical test was performed on the inkjet recording apparatus. As a result, it was confirmed that the inkjet recording apparatus can record high quality images for a longer time, compared with inkjet recording apparatuses that include a conventional inkjet head. That is, it was confirmed that the deterioration caused by the sliding of the wiping mechanism can be suppressed and the initial water-repellent performance can be kept.

### Modifications

Note that the present invention is not limited to the above-described embodiments and examples, and can be modified within the technical spirit of the present invention.

For example, although not described in the examples, another water-repellent film material having a skeleton expressed by the structural formula (3) or (4) may be used. In this case, the water repellent film made of perfluoropolyether may be formed by using FG-5083SH made by Fluoro Technology LTD.

In addition, in Example 5, a unit that corresponds to a plurality of inkjet heads is made as one body by sticking wafers to each other, then the water repellent film is applied onto the unit, and then the unit is divided into the individual inkjet heads by performing the dicing on the unit. However, the manufacturing method is not limited to this. For example, flow channel-substrates and an orifice plate may be prepared and assembled into each single inkjet head. In addition, the water repellent film may not be applied to the orifice plate after the inkjet head is assembled, and may be applied to the orifice plate before the inkjet head is assembled.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-020655, filed Feb. 14, 2023, which is hereby incorporated by reference herein in its entirety.

What is claimed is:

1. A water repellent member comprising:
a foundation material;
a base layer formed on the foundation material;
projections formed on the base layer and dispersed;
a first water-repellent member formed on the base layer in contact with the base layer; and
a second water-repellent member formed on the projections in contact with the projections,
wherein the first water-repellent member and the second water-repellent member are a perfluoropolyether compound, and
wherein if an oxide that is a main component of the base layer is denoted by AO, an oxide that is a main component of the projections is denoted by BO, an electronegativity of an element A is denoted by XA, an electronegativity of an element B is denoted by XB, and an electronegativity of oxygen is denoted by XO, a covalent binding index exp(−0.25(XA−XO)²) of the AO is smaller than a covalent binding index exp(−0.25(XB−XO)²) of the BO.

2. The water repellent member according to claim 1, wherein the AO is selected from the group consisting of Ta₂O₅, Nb₂O₅, TiO₂, HfO₂, ZrO₂, Y₂O₃, CeO₂, Al₂O₃, and Cr₂O₃, and
wherein the BO is selected from the group consisting of SiO₂, Ta₂O₅, Nb₂O₅, TiO₂, HfO₂, ZrO₂, Y₂O₃, CeO₂, Al₂O₃, and Cr₂O₃.

3. The water repellent member according to claim 1, wherein the perfluoropolyether compound includes at least one repeated structure selected from the group of repeated structures expressed by following structural formulas (1) to (4):

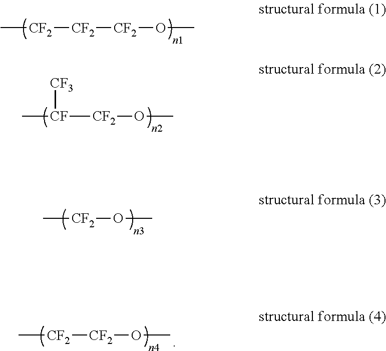

4. The water repellent member according to claim 1, wherein a difference between a height of the first water-repellent member obtained after an elastic member slides on a water repellent surface of the water repellent member and a height of the second water-repellent member obtained after the elastic member slides on the water repellent surface of the water repellent member is substantially equal to a height of the projections.

5. The water repellent member according to claim 1, wherein a speed at which the first water-repellent member wears and which is obtained when an elastic member slides on a water repellent surface of the water repellent member is substantially equal to a speed at which the second water-repellent member wears and which is obtained when the elastic member slides on the water repellent surface of the water repellent member.

6. An inkjet head comprising:
an orifice plate including an ejection orifice,
wherein the orifice plate includes
a foundation material,
a base layer formed on the foundation material,
projections formed on the base layer and dispersed,
a first water-repellent member formed on the base layer in contact with the base layer, and
a second water-repellent member formed on the projections in contact with the projections, and
wherein the first water-repellent member and the second water-repellent member are a perfluoropolyether compound, and
wherein if an oxide that is a main component of the base layer is denoted by AO, an oxide that is a main component of the projections is denoted by BO, an electronegativity of an element A is denoted by XA, an electronegativity of an element B is denoted by XB, and an electronegativity of oxygen is denoted by XO, a covalent binding index exp(−0.25(XA−XO)²) of the AO is smaller than a covalent binding index exp(−0.25(XB−XO)²) of the BO.

7. The inkjet head according to claim 6, wherein the AO is selected from the group consisting of Ta₂O₅, Nb₂O₅, TiO₂, HfO₂, ZrO₂, Y₂O₃, CeO₂, Al₂O₃, and Cr₂O₃, and
wherein the BO is selected from the group consisting of SiO₂, Ta₂O₅, Nb₂O₅, TiO₂, HfO₂, ZrO₂, Y₂O₃, CeO₂, Al₂O₃, and Cr₂O₃.

8. The inkjet head according to claim 6, wherein the perfluoropolyether compound includes at least one repeated structure selected from the group of repeated structures expressed by following structural formulas (1) to (4):

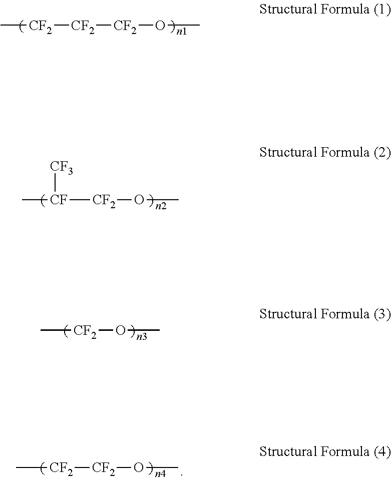

9. The inkjet head according to claim 6, wherein a difference between a height of the first water-repellent member obtained after a wiper slides on the first water-repellent member and the second water-repellent member and a height of the second water-repellent member obtained after the wiper slides on the first water-repellent member and the second water-repellent member is substantially equal to a height of the projections.

10. The inkjet head according to claim 6, wherein a speed at which the first water-repellent member wears and which is obtained when a wiper slides on the first water-repellent member and the second water-repellent member is substantially equal to a speed at which the second water-repellent member wears and which is obtained when the wiper slides on the first water-repellent member and the second water-repellent member.

11. A method of manufacturing a water repellent member comprising:
forming a base layer on a foundation material;
forming projections on the base layer such that the projections are dispersed, the projections containing a main component whose covalent binding index is larger than a covalent binding index of a main component of the base layer; and
forming a water repellent film that contains a perfluoropolyether compound, and that is in contact with the base layer and the projections.

12. The method of manufacturing a water repellent member according to claim 11, wherein if an oxide that is a main component of the base layer is denoted by AO, an oxide that is a main component of the projections is denoted by BO, an electronegativity of an element A is denoted by XA, an electronegativity of an element B is denoted by XB, and an electronegativity of oxygen is denoted by XO, a covalent binding index exp(−0.25(XA−XO)²) of the AO is smaller than a covalent binding index exp(−0.25(XB−XO)²) of the BO.

13. The method of manufacturing a water repellent member according to claim 12, wherein the AO is selected from the group consisting of Ta₂O₅, Nb₂O₅, TiO₂, HfO₂, ZrO₂, Y₂O₃, CeO₂, Al₂O₃, and Cr₂O₃, and
wherein the BO is selected from the group consisting of SiO₂, Ta₂O₅, Nb₂O₅, TiO₂, HfO₂, ZrO₂, Y₂O₃, CeO₂, Al₂O₃, and Cr₂O₃.

14. The method of manufacturing a water repellent member according to claim 11, wherein the perfluoropolyether compound includes at least one repeated structure selected from the group of repeated structures expressed by following structural formulas (1) to (4):

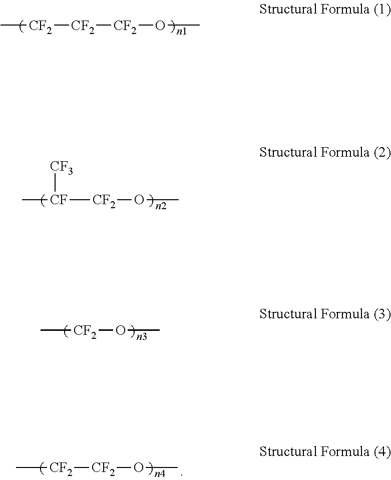

15. A method of manufacturing an inkjet head comprising:
manufacturing an orifice plate by using the method of manufacturing a water repellent member according to claim 11.

16. The water repellent member according to claim 1, wherein the AO is any one of Ta₂O₅, Nb₂O₅, HfO₂, and ZrO₂, and
wherein the BO is SiO₂.

17. The inkjet head according to claim 6, wherein the AO is any one of Ta₂O₅, Nb₂O₅, HfO₂, and ZrO₂, and
wherein the BO is SiO₂.

18. The method of manufacturing a water repellent member according to claim 12, wherein the AO is any one of Ta₂O₅, Nb₂O₅, HfO₂, and ZrO₂, and
wherein the BO is SiO₂.
